(19) United States
(12) Patent Application Publication
(10) Pub. No.: US 2009/0254888 A1
(43) Pub. Date: Oct. 8, 2009

(54) DEBUG TOURS FOR SOFTWARE DEBUGGING

(75) Inventors: Peter A. Nicholls, Janetville (CA); Jeremiah S. Swan, Stouffville (CA); Jeffrey C. Turnham, Newmarket (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/099,012

(22) Filed: Apr. 7, 2008

(51) Int. Cl. G06F 11/36

(52) U.S. Cl. 717/129

(57) ABSTRACT

Embodiments of the present invention address deficiencies of the art in respect to source code debugging and provide a method, system and computer program product for debug tours for debugging source code. In an embodiment of the invention, a debugger data processing system can be provided. The system can include a debugger executing in a host computing platform, and a debug tour manager coupled to the debugger. The debug tour manager can include program code enabled to load a debug tour of an ordered set of breakpoints established during a prior debugging session of source code, to apply the breakpoints in the debug tour to separately loaded source code, and to execute the source code and to invoke the applied breakpoints in an order prescribed by the ordered set within the debugger.

### BACKGROUND OF THE INVENTION

1. Field of the Invention

The present invention relates to the field of software development and more particularly to software debugging.

2. Description of the Related Art

The art of software development extends far beyond a mere coding of a functional specification for a computer program. Modern software development conforms to a lifecycle which begins with the functional specification leading into the formulation of a suitable architecture for an application implementing the functional specification. The lifecycle continues with the physical coding of the application and includes iterative testing and debugging cycles to ensure the integrity of the code. Finally, the execution of the debugged code can be analyzed to facilitate the further revision of the code to improve the performance of the code.

The debugging process has changed little in the past decades. Generally, a debugger provided by an integrated development environment (IDE) allows the debugger to set breakpoints on lines of source code. During execution of the source code, the execution can break on each line having an established breakpoint. While the source code remains in stasis provided by the breakpoint, the debugger can inspect the values of variables and memory in general in order to determine whether or not the source code has executed as planned. As any developer will attest, the liberal use of the breakpoint during debugging is an essential aspect of the debugging process.

The act of setting a breakpoint or set of breakpoints can be largely characterized as ad-hoc in nature. That is to say, developers set and reset breakpoints at will. As such, depending upon the number and nature of breakpoints set on source code in an IDE, the debugging process can vary from debugging session to debugging session. Notably, while a breakpoint once set on a line of source code can be meaningful to the developer at the time of setting the breakpoint, subsequently the breakpoint may have lost its meaning. Yet, the debugger is forced to recall at every instance the purpose of an established breakpoint.

Further, one can arrive at the same code path in source code from many different places in the source code. Consequently, while an established breakpoint can be meaningful when arriving at the breakpoint from an expected place in the source code, the same established breakpoint can be confusing if arrived at from a different place in the source code. Accordingly, the context of the path through source code is wholly lost when setting individual breakpoints in source code during a debugging session.

### BRIEF SUMMARY OF THE INVENTION

Embodiments of the present invention address deficiencies of the art in respect to source code debugging and provide a novel and non-obvious method, system and computer program product for debug tours for debugging source code. In an embodiment of the invention, a debugger data processing system can be provided. The system can include a debugger executing in a host computing platform, and a debug tour manager coupled to the debugger. The debug tour manager can include program code enabled to load a debug tour of an ordered set of breakpoints established during a prior debugging session of source code, to apply the breakpoints in the debug tour to separately loaded source code, and to execute the separately loaded source code with applied breakpoints in an order provided by the ordered set within the debugger.

The breakpoints can include both instances of a waypoint and also a checkpoint. Each of the instances can include a description and each of the instances also can include a trigger based upon any of a line of separately loaded source code, a system event, an application event, a stack pattern, and a timer. An instance of a checkpoint further can include a condition upon which a continuation of execution of the source code is based. Further, an instance of a checkpoint also can include a condition upon which a continuation of a suspended debug tour is based.

In another embodiment of the invention, a debugging method can be provided. The method can include loading a debug tour of an ordered set of breakpoints established during a prior debugging session of source code, applying the breakpoints in the debug tour to separately loaded source code, and executing the separately loaded source code and invoking the applied breakpoints in an order provided by the ordered set. Loading a debug tour of an ordered set of breakpoints established during a prior debugging session of source code, can include loading a debug tour of an ordered set of both waypoints and checkpoints established during a prior debugging session of source code.

In one aspect of the embodiment, applying the breakpoints in the debug tour to the separately loaded source code can include applying the breakpoints in the debug tour to the separately loaded source code in connection with a trigger such as a location in the source code, a system or application event, a stack pattern, or a timer. In another aspect of the embodiment, executing the separately loaded source code and invoking the applied breakpoints in an order provided by the ordered set can include executing the separately loaded source code and invoking both applied waypoints and checkpoints in an order provided by the ordered set and providing notification only where a deviation from an expected code path occurs.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of debug tour management process for debugging source code;

FIG. 2 is a schematic illustration of a debugger data processing system configured for debug tour management; and,

FIG. 3 is a flow chart illustrating a process for debug tour management for debugging source code.

### DETAILED DESCRIPTION OF THE INVENTION

Embodiments of the present invention provide a method, system and computer program product for debug tour management for debugging source code. In accordance with an embodiment of the present invention, an ordered set of breakpoints can be established for different lines of source code in a debug target in a first debugging session as a debug tour. The set of breakpoints can include checkpoints, waypoints or both. Thereafter, the set of breakpoints can be persisted separately from the debug target as a debug tour. Subsequently, the debug tour can be loaded and applied to a debug target in a second debugging session. In this way, an ordered set of breakpoints can be persisted for re-use to speed problem solving in the debug environment.

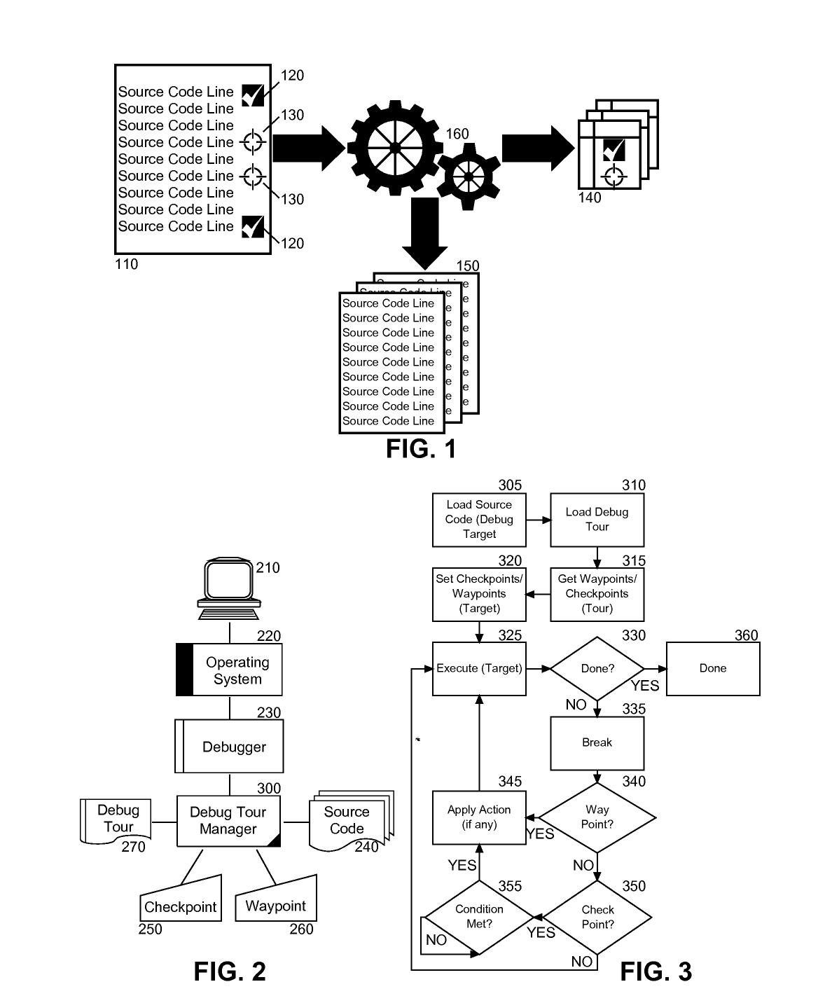

In illustration, FIG. 1 pictorially depicts a debug tour management process for debugging source code. As shown in FIG. 1, different breakpoints 120, 130 can be established for different lines of source code 110. The breakpoints 120, 130 can include both checkpoints 120 and waypoints 130. Each of the checkpoints 120 can be a breakpoint in which execution of the source code 110 is not permitted until a condition has been satisfied. Each of the waypoints 130, but comparison can be a breakpoint in which continuation of a debug tour 140 is suspended until a pre-specified condition has been satisfied. For both checkpoints 120 and waypoints 130, actions can be performed upon the debug tour 140 reaching the checkpoints 120 and waypoints 130 include logging and reporting.

A debug tour manager 160 can aggregate a set of the established breakpoints 120, 130 in a prescribed order into a debug tour 140 stored separately from the source code 110. In this regard, the ordered set of breakpoints 120, 130 in the debug tour 140 can be individually documented such that breakpoint re-use can be facilitated with the intent to reduce the ad hoc nature of breakpoint placement during a debugging session. Consequently, the debug tour manager 160 can load a debug tour 140 for application to source code 150 in different subsequent debugging sessions through which the ordering, nature and intent of the breakpoints 120, 130 can be recognized by the debugger. In this way, the debugging process can be speeded with clarity through the re-use of the breakpoints 120, 130 in a order specified by the debug tours 140.

The process illustrated in FIG. 1 can be employed in a debugger data processing system. In illustration, FIG. 2 is a schematic illustration of a debugger data processing system configured for debug tour management. The system can include a host computing platform 210 supporting the execution of an operating system 220. The operating system 220 in turn can be configured to manage the operation of one or more applications, including a debugger 230. The debugger 230 can be programmed to provide a development environment in which source code 240 can be executed incrementally through the use of breakpoints in order to debug the source code 240.

As part of the debugging process, at each breakpoint in the source code 240, the execution of the source code 240 can pause in order to permit the manual inspection of data elements in memory resulting from the execution of the source code 240 and also source code lines resulting in program exceptions can be identified. Notably, a debug tour manager 300 can be coupled to the debugger 230. The debug tour manager 300 can include program code enabled to define and set instances of both a checkpoint 250 and a waypoint 260 in the source code 240. The program code of the debug tour manager 300 further can be enabled to aggregate the instances of the checkpoint 250 and waypoint 260 for the source code 240 in a debug tour 270. The program code of the debug tour manager 300 yet further can be enabled to load the debug tour 270 during a subsequent debugging session of the source code 240 and to apply the instances of the checkpoint 250 and the waypoint 260 to the source code 240.

The waypoint 250 can be a breakpoint containing properties allowing an instance of the waypoint 250 to be aggregated into a debug tour 270. The properties can include, by way of example, a description and one or more tags. The properties further can include a trigger resulting from a source code location, a stack pattern, a system event or an application event. Similarly, the checkpoint 260 can be a breakpoint also containing properties allowing an instance of the checkpoint 260 to be aggregated into a debug tour 270. The properties can be similar to those of the waypoint 250 and in addition the checkpoint 260 can include a trigger resulting from a lapse of a timer. Also, unlike an instance of a waypoint 250, the properties can include a condition upon which resumption of the debug tour 270 can depend.

During execution of the source code 240, an expected set of instances of a waypoint 250 can be encountered. At each encounter of an instance of a waypoint 250, an action associated with the instance, if any, can be performed. Optionally, no indication of the encounter of the instance of the waypoint 250 need be provided so long as the ordering of the encountered instances of the waypoint 250 is consistent with the expected sequence of instances of the waypoint 250 as set forth in the debug tour 270. In any event, a visualization of the debug tour 270 can be provided during the execution of the source code 240.

In further illustration of the operation of the debug tour manager 300, FIG. 3 is a flow chart illustrating a process for debug tour management for debugging source code. Beginning in block 305, source code can be loaded as a debug target in a debugger. In block 310, a debug tour previously persisted can be loaded for application to a debugging session for the debug target in the debugger. In block 315, the waypoints and checkpoints of the debug tour can be retrieved and in block 320 the retrieved waypoints and checkpoints can be applied to the debug target. Thereafter, in block 325 the debug target can be executed in the debugger.

In decision block 330, if the execution of the source code has not completed, in block 335 a breakpoint can be encountered. The breakpoint can be a waypoint or a checkpoint and can be encountered in association with a line of source code, through the lapse of a timer, through the occurrence of an application or system event, or through a pattern recognized in the stack. In decision block 340, it can be determined if the breakpoint is a waypoint. If so, in block 345 an action associated with the waypoint can be executed, if any, and the process can return to block 325. Otherwise, in decision block 350 it can be determined if the breakpoint is a checkpoint. If so, in decision block 355 it can be determined if the condition associated with the checkpoint has been met. Only once the condition has been met can the process continue to block 345 with the execution of an associated action, if any. In decision block 330, when the execution concludes, in block 360 the process can end.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A debugger data processing system comprising:
a debugger executing in a host computing platform;
a debug tour manager coupled to the debugger, the debug tour manager comprising program code enabled to load a debug tour of an ordered set of breakpoints established during a prior debugging session of source code, to apply the breakpoints in the debug tour to separately loaded source code, and to execute the separately loaded source code with applied breakpoints in an order provided by the ordered set within the debugger.

2. The system of claim 1, wherein the breakpoints comprise both instances of a waypoint and also a checkpoint.

3. The system of claim 2, wherein each of the instances comprises a description.

4. The system of claim 3, wherein each of the instances comprises a trigger based upon any of a line of source code, a system event, an application event, a stack pattern, and a timer.

5. The system of claim 3, wherein an instance of a checkpoint further comprises a condition upon which a continuation of the debug tour is based.

6. A debugging method comprising:
loading a debug tour of an ordered set of breakpoints established during a prior debugging session of source code;
applying the breakpoints in the debug tour to separately loaded source code; and,
executing the separately loaded source code and invoking the breakpoints in an order provided by the ordered set.

7. The method of claim 6, wherein loading a debug tour of an ordered set of breakpoints established during a prior debugging session of source code, comprises loading a debug tour of an ordered set of both waypoints and checkpoints established during a prior debugging session of source code.

8. The method of claim 7, wherein applying the breakpoints in the debug tour to the separately loaded source code, comprises applying the breakpoints in the debug tour to the separately loaded source code in connection with a trigger comprising a location in the separately loaded source code.

9. The method of claim 7, wherein applying the breakpoints in the debug tour to the separately loaded source code, comprises applying the breakpoints in the debug tour to the separately loaded source code in connection with a trigger comprising a system or application event.

10. The method of claim 7, wherein applying the breakpoints in the debug tour to the separately loaded source code, comprises applying the breakpoints in the debug tour to the separately loaded source code in connection with a trigger comprising a stack pattern.

11. The method of claim 7, wherein executing the separately loaded source code and invoking the breakpoints in an order provided by the ordered set, comprises executing the separately loaded source code and invoking the applied waypoints and providing notification only where a deviation from an expected code path occurs.

12. A computer program product comprising a computer usable medium embodying computer usable program code for debugging, the computer program product comprising:
computer usable program code for loading a debug tour of an ordered set of breakpoints established during a prior debugging session of source code;
computer usable program code for applying the breakpoints in the debug tour to separately loaded source code; and,
computer usable program code for executing the separately loaded source code and invoking the applied breakpoints in an order provided by the ordered set.

13. The computer program product of claim 12, wherein the computer usable program code for loading a debug tour of an ordered set of breakpoints established during a prior debugging session of source code, comprises computer usable program code for loading a debug tour of an ordered set of both waypoints and checkpoints established during a prior debugging session of source code.

14. The computer program product of claim 13, wherein the computer usable program code for applying the breakpoints in the debug tour to the separately loaded source code, comprises computer usable program code for applying the breakpoints in the debug tour to the separately loaded source code in connection with a trigger comprising a location in the separately loaded source code.

15. The computer program product of claim 13, wherein the computer usable program code for applying the breakpoints in the debug tour to the separately loaded source code, comprises computer usable program code for applying the breakpoints in the debug tour to the separately loaded source code in connection with a trigger comprising a system or application event.

16. The computer program product of claim 13, wherein the computer usable program code for applying the breakpoints in the debug tour to the separately loaded source code, comprises computer usable program code for applying the breakpoints in the debug tour to the separately loaded source code in connection with a trigger comprising a stack pattern.

17. The computer program product of claim 13, wherein the computer usable program code for executing the separately loaded source code and invoking the applied breakpoints in an order provided by the ordered set, comprises computer usable program code for executing the separately loaded source code and invoking the applied waypoints and providing notification only where a deviation from an expected code path occurs.
